(19) United States
(12) Patent Application Publication
(10) Pub. No.: US 2026/0368732 A1
(43) Pub. Date: Nov. 19, 2026

(54) ENABLING REMOTE AUTHORIZATION OF CARDLESS PAYMENT TRANSACTIONS

(71) Applicant: VERIFCNEO, INC., Wilmington, DE (US)

(72) Inventors: Yusuf Zainee, Bangalore (IN); Smarajit Mishra, Bhubaneswar (IN)

(73) Assignee: VERIFCNEO, INC., Wilmington, DE (US)

(21) Appl. No.: 19/158,744

(22) PCT Filed: Mar. 3, 2023
(86) PCT No.: PCT/US23/63674

§ 371 Date: Aug. 21, 2025

(51) Int. Cl. G06Q 20/40

(52) U.S. Cl. CPC G06Q 20/4014

(57) ABSTRACT

Methods, devices, and non-transitory computer readable media for enabling remote authorization of payment transactions are provided herein. The methods, devices, and non-transitory computer readable media enable authorization of cardless payment transactions, such as transactions where the credit card being utilized for the payment is not present at the payment terminal.

### FIELD OF THE DISCLOSURE

The present disclosure is directed generally to methods, devices, and non-transitory computer readable media for enabling remote authorization of cardless payment transactions.

### BACKGROUND

Circumstances may arise where a credit card holder wants to authorize another person, such as a family member, to utilize their credit card when they are not present. For example, a family member may encounter a discount at a retail location that the card holder for which the card holder wants to take advantage.

However, most retail credit card transactions require that the card holder be present with the card to swipe, insert, or tap the card at the payment terminal. Even if the credit card information could be manually entered at the payment terminal, for example if the card holder shares the credit card number with the family member, such a transaction would require that the credit card holder also provide a personal identification number or other security feature. Thus, the card holder may be unable to realize the discount.

### SUMMARY OF THE DISCLOSURE

The present disclosure is directed to methods, devices, and non-transitory computer readable media for enabling remote authorization of payment transactions. More specifically, the present disclosure is directed to methods, devices, and non-transitory computer readable media for remote authorization of cardless payment transactions, such as transactions where the credit card being utilized for the payment is not present at the payment terminal.

According to an example of the present disclosure, a method for enabling authorization of a cardless payment transaction is provided. The method includes: (i) receiving, by a payment authorization computing device, a notification of initiation of a cardless payment transaction on a credit card from a payment terminal, wherein the notification comprises identification data related to a holder of the credit card for payment of the cardless payment transaction; (ii) determining, by the payment authorization computing device, an identity of the holder of the credit card based on the identification data, wherein the identity of the holder of the credit card comprises a mobile device associated with the holder of the credit card; (iii) determining, by the payment authorization computing device, whether the credit card holder has enabled cardless payment transactions; (iv) sending, by the payment authorization computing device, a request for authorization of the cardless payment transaction to the mobile device associated with the holder of the credit card; and (v) providing, by the payment authorization computing device, an approval for the cardless payment transaction to the payment terminal based on an authentication provided by the holder of the credit card on the mobile device in response to the request for authorization of the cardless payment transaction.

In an aspect, the notification of the initiation of the cardless payment transaction is based on a user selection on the payment terminal.

In an aspect, the credit card is not located in the proximity of the payment terminal during the cardless payment transaction.

In an aspect, the identification data comprises a credit card number for the credit card, personal identification number, an e-mail address, or a phone number for the holder of the credit card.

In an aspect, the determining the identity of the holder of the credit card comprises:
(i) sending, by the payment authorization computing device, a query to a database comprising identification data for a plurality of cardholders; and (ii) receiving, by the payment authorization computing device, the identity of the credit card holder from the database in response to the query.

In an aspect, the determining the identity of the holder of the credit card comprises:
(i) determining, by the authorization computing device, whether the holder of the credit card has registered to allow cardless payment transactions; and (ii) sending, by the authorization computing device, a denial of the cardless payment transaction to the payment terminal when it is determined that the holder of the credit card has not registered to allow cardless payment transactions.

In an aspect, the determining whether the credit card holder has enabled cardless payment transactions is performed prior to sending the request for authorization of the cardless payment transaction to the mobile device associated with the holder of the credit card.

In an aspect, information related to whether the credit card holder has enabled cardless payment transactions is stored in a database along with the identity of the card holder.

In an aspect, the information related to whether the credit card holder has enabled cardless payment transactions indicates a temporal period during which cardless payment transactions are enabled.

In an aspect, the information related to whether the credit card holder has enabled cardless payment transactions indicates a transaction type or transaction amount for which cardless payment transactions are enabled.

In an aspect, the request for authorization comprises transaction data related to the cardless payment transaction from the payment terminal.

In an aspect, the transaction data comprises a transaction location, a transaction type, or a transaction amount.

In an aspect, the authentication comprises a personal identification code associated with the credit card holder or a biometric identification of the credit card holder.

According to another example of the present disclosure, a remote payment authorization computing device is provided. The remote payment authorization computing device comprises a memory comprising programmed instructions stored thereon, and one or more processors configured to be capable of executing the stored programmed instructions to: (i) receive a notification of initiation of a cardless payment transaction on a credit card from a payment terminal, wherein the notification comprises identification data related to a holder of the credit card for payment of the cardless payment transaction; (ii) determine whether the holder of the credit card has registered to allow cardless payment transactions based on the identification data; (iii) determine whether the credit card holder has enabled cardless payment transactions; (iv) send a request for authorization of the cardless payment transaction to the mobile device associated with the holder of the credit card; and (v) provide an approval for the cardless payment transaction to the payment terminal based on an authentication provided by the holder of the credit card on the mobile device in response to the request for authorization of the cardless payment transaction.

According to another example of the present disclosure, a method for authorizing a cardless payment transaction on a user computing device associated with a holder of a credit card is provided. The method includes: (i) sending, by the user computing device, one or more user preferences to a payment authorization computing device, wherein the one or more user preferences can be used by the payment authorization computing device to determine whether the holder of the credit card has enabled the cardless payment transaction; (ii) receiving, by the user computing device, a request for authorization of the cardless payment transaction when the payment authorization computing device determines that the holder of the credit card has enabled the cardless payment transaction based on the one or more user preferences; and (iii) sending, by the user computing device, an authentication provided by the holder of the credit card on the user computing device to the payment authorization computing device in response to the request for authorization of the cardless payment transaction to authorize the cardless payment transaction.

In one aspect, the one or more user preferences comprise a temporal period during which cardless payment transactions are enabled, a transaction type for which cardless payment transactions are enabled, or a transaction amount for which cardless payment transactions are enabled.

These and other aspects of the various embodiments will be apparent from and elucidated with references to the embodiment(s) described hereinafter.

### BRIEF DESCRIPTION OF THE DRAWINGS

FIG. 1 is a diagram illustrating an environment including a remote payment authorization computing device configured to perform the methods according to aspects of the present disclosure.

FIG. 2 is a block diagram of the remote payment authorization computing device illustrated in FIG. 1 according to aspects of the present disclosure.

FIG. 3 is a flow diagram for initiating a cardless payment transaction on the payment terminal illustrated in FIG. 1.

FIG. 4 is a block diagram of the user device illustrated in FIG. 1 according to aspects of the present disclosure.

FIG. 5 is a flow diagram illustrating the initial setup of a remote authorization account according to aspects of the present disclosure.

FIGS. 6A and 6B are a flow diagram illustrating a method for enabling remote authorization of a cardless payment transaction according to aspects of the present disclosure.

### DETAILED DESCRIPTION

The present disclosure is directed to methods, devices, and non-transitory computer readable media for enabling remote authorization of payment transactions. More specifically, the present disclosure is directed to methods, devices, and non-transitory computer readable media for remote authorization of cardless payment transactions, such as transactions where the credit card being utilized for the payment is not present at the payment terminal. Further, the present disclosure allows the credit card holder to toggle on and off when remote transactions will be authorized.

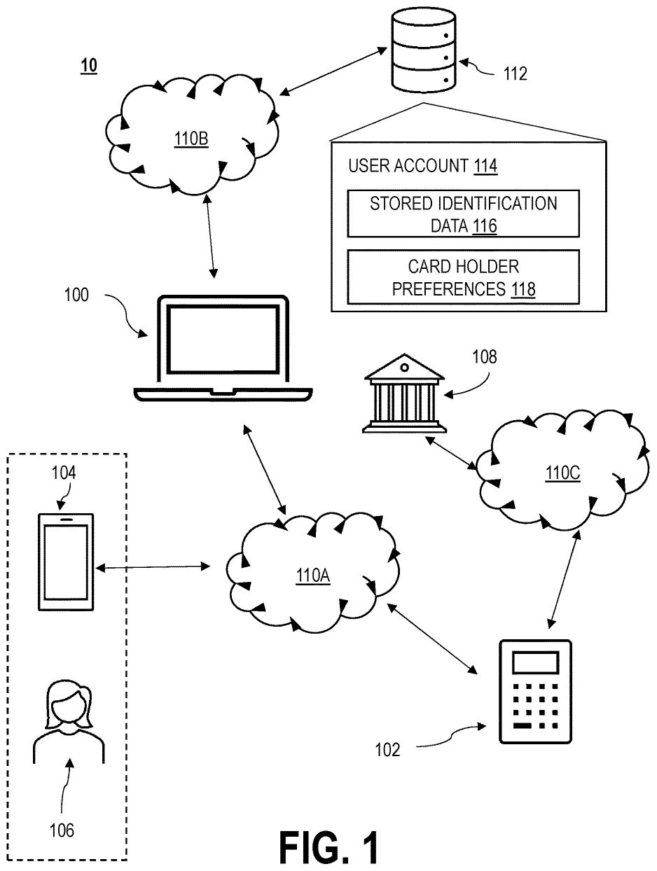

FIG. 1 illustrates an environment 10 including an exemplary remote payment authorization computing device 100 coupled to a payment terminal 102 and a user device 104 associated with a credit card holder 106, by one or more communication network(s) 110A. The remote payment authorization computing device 100 is further coupled to a database 112 by one or more communication network(s) 110B. The payment terminal 102 is coupled to a payment processor 108 by one or more communication networks 110C. Although the environment 10 is illustrated and described, the environment may include additional numbers and/or types of devices in other configurations. For example, although payment terminal 102, user device 104, and payment processor 108 are illustrated, it is to be understood that the environment 10 may include any number of payment terminals, user devices, and payment processors coupled to remote payment authorization computing device 102 to provide remote authorization of cardless payment transactions in accordance with the methods disclosed herein. Further, although communication networks 110A-110C are illustrated, it is to be understood that the environment could include a single communication network. The technology of the present disclosure advantageously allows remote authorization of cardless payment transactions, e.g., transactions where the credit card is not physically present at the payment terminal.

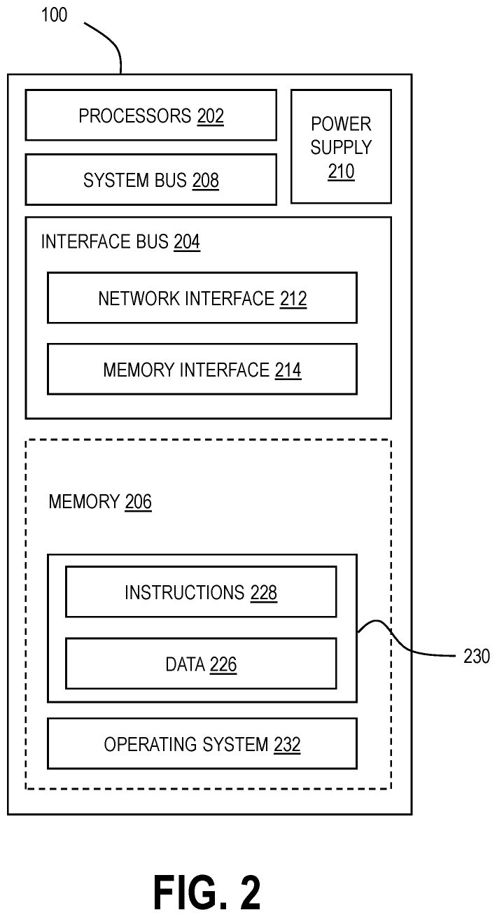

Remote payment authorization computing device 100 is configured to provide remote authorization of a cardless payment transaction according to aspects of the present disclosure. With reference to FIG. 2, a block diagram of the remote payment authorization computing device 100 is illustrated according to aspects of the present disclosure. In the example of FIG. 2, the remote payment authorization computing device 100 can include one or more processors 202, an interface bus 204, and machine-readable memory 206, all of which may be interconnected and/or communicate through a system bus 208 containing conductive circuit pathways through which instructions (e.g., machine-readable signals) may travel to effectuate communication, tasks, storage, and the like. The remote payment authorization computing device 100 may be connected to a power source 210, which can include an internal power supply and/or an external power supply.

The one or more processors 202 may include a high-speed data processor adequate to execute the program components described herein and/or various specialized processing units as may be known in the art. In some examples, the one or more processors 202 may be a single processor, multiple processors, or multiple processor cores on a single die.

In some examples, the interface bus 204 may include a network interface 212 configured to connect and communicate with one or more connected electronic devices, including payment terminal 102, user device 104, and database 112, for example, through the one or more communications network(s) 110A and/or 110B, as shown in FIG. 1, and/or a memory interface 214 configured to accept, communicate, and/or connect to a number of machine-readable memory devices (e.g., memory 206).

The memory 206 can be variously embodied in one or more forms of machine-accessible and machine-readable memory. For example, the memory 206 can include, but is not limited to, a non-transitory storage medium, a magnetic disk storage, an optical disk storage, an array of storage devices, a solid-state memory device, and the like, including combinations thereof.

Generally, the memory 206 is configured to store data/information 226 and instructions 228 that, when executed by the one or more processors 202, causes the remote payment authorization computing device 100 to perform one or more tasks. In particular examples, the memory 206 includes a controller package 230 that comprises a collection of program components, database components, and/or data configured to, when executed by the one or more processors 202, cause the remote payment authorization computing device 100 to perform one or more of the steps of the methods described herein for enabling remote authorization of a cardless payment transaction. According to the present disclosure, the controller package 230 may include, but is not limited to, instructions 228 configured to perform one or more of the steps of the methods disclosed herein. These instructions 228 may be incorporated into, loaded from, loaded onto, or otherwise operatively available to and from the remote payment authorization computing device 100. In embodiments, the remote payment authorization computing device 100 includes at least an operating system component 232, which may be stored in the memory 206. The operating system component 232 may be an executable program facilitating the operation of the controller package 230. Typically, the operating system component 232 can facilitate access of the network interface 212 and memory interface 214, and can communicate with other components of the remote payment authorization computing device 100.

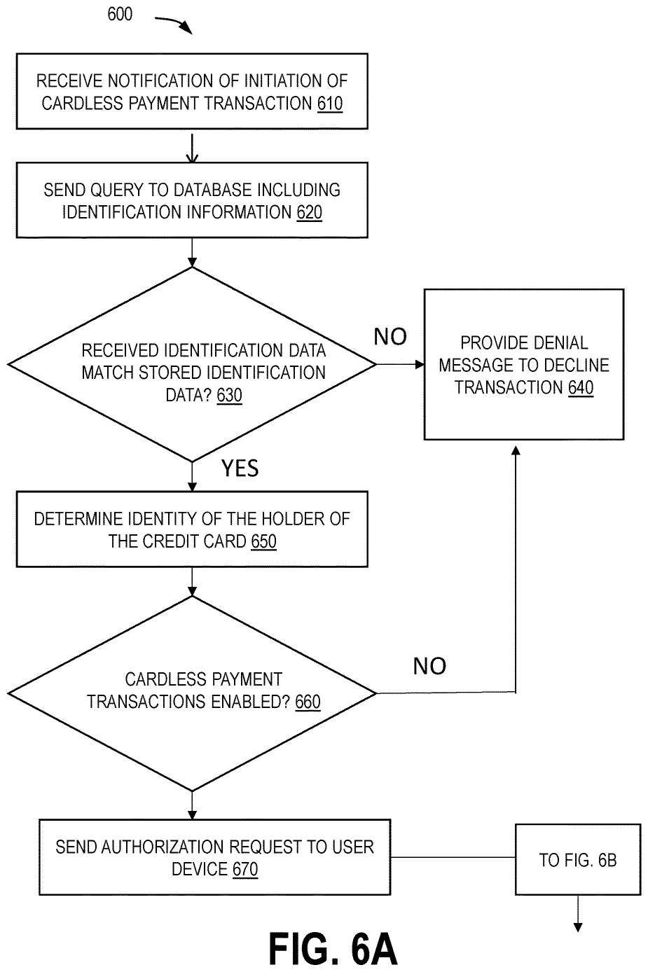

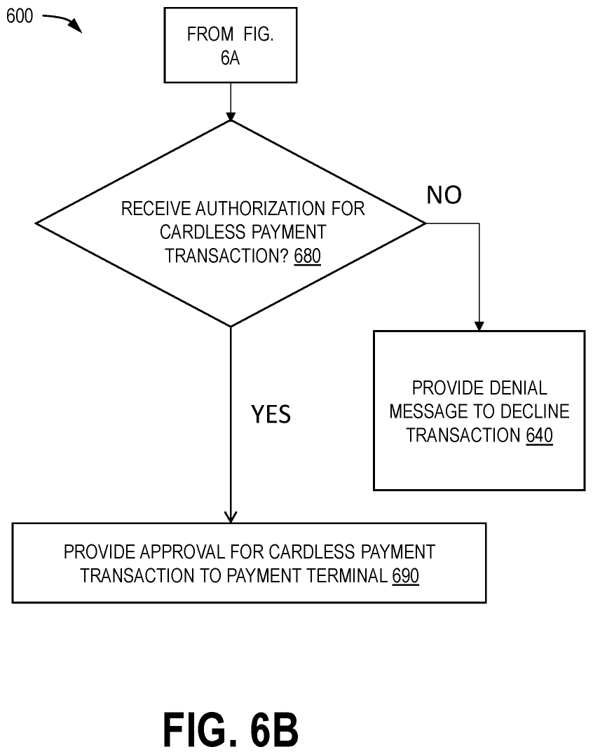

Referring again to FIG. 1, the remote payment authorization computing device 100 is communicatively coupled to database 112 through the one or more communication network(s) 110B. The database 112 can be used to store information related to the methods performed by the remote payment authorization computing device 100 according to aspects of the present disclosure. In this example, the database 112 includes user account 114 for the credit card holder 106 who has registered to utilize cardless payment transactions through the remote payment authorization computing device 100, as described in further detail below in FIG. 6. Although user account 114 for the credit card holder 106 is illustrated and described, it is to be understood that the database 112 can include any number of user accounts for any number of credit card holders to utilize the methods for enabling remote authorization of cardless payment transactions according to aspects of the present disclosure.

In this example, the user account 114 is associated with the credit card holder 106 and includes stored identification data 116 related to the credit card holder 106. For example, the stored identification data 116 can include a credit card number for the credit card, personal identification number, an e-mail address, residential address, or a phone number for the credit card holder 106, although other forms of identification data may be employed to identify the credit card holder 106. In this example, the user account 114 also includes optional card holder preferences 116 identified by the credit card holder 106. By way of example, the credit card holder 106 can provide card holder preferences 116 to enable/disable cardless payment transactions and/or to provide limits on when cardless payment transactions are enabled, as described in further detail below.

Referring again to FIG. 1, the remote payment authorization computing device 100 is communicatively coupled to the payment terminal 102 through the one or more communication network(s) 110A to receive notification of an initiation of a cardless payment transaction according to aspects of the present disclosure. Although payment terminal 102 is illustrated and described, it is to be understood that remote payment authorization computing device 100 could be communicatively coupled to any number of payment terminals for performing the methods described herein. In this example, payment terminal 102 is associated with a retail outlet and is configured to process payment transactions, including credit card payment transactions through communications with payment processor 108, as described below. Payment terminal 102 is further configured to provide a notification of an initiation of a cardless payment to the remote payment authorization computing device 100, as described in further detail below.

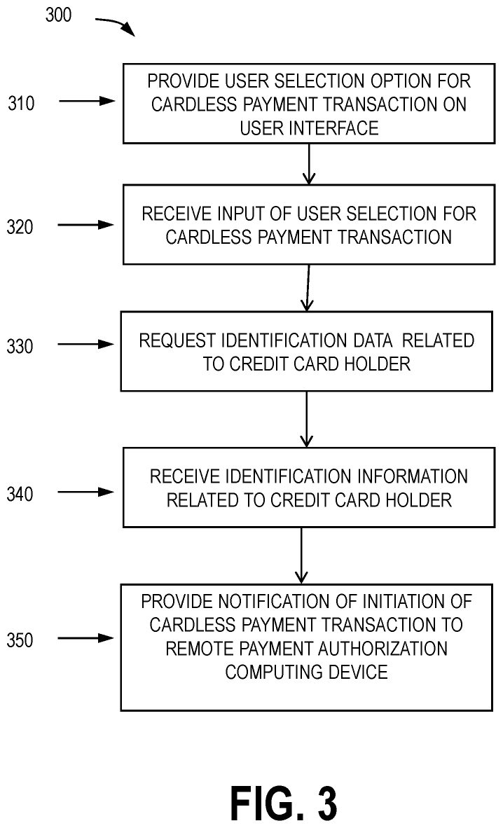

FIG. 3 illustrates a method 300 of initiating a cardless payment transaction on the payment terminal 102 illustrated in FIG. 1. In step 310, the payment terminal provides a user selection option for selecting a cardless payment transaction on the user interface of the payment terminal 102. By way of example, the cardless payment option may be selected when the individual executing the payment transaction is not the credit card holder 106 and the credit card is not located in the proximity of the payment terminal 102 to execute the transaction. The cardless payment user selection option may be provided along with other payment options, such as a credit card or debit card selections. In step 320, the payment terminal 102 receives a user selection of the cardless payment transaction option through the user interface. In response to the user selection of the cardless payment transaction, in step 330 the payment terminal 102 requests identification data, through a display screen, in order to identify the credit card holder 106 for the cardless payment transaction through a correlation with the stored identification data 116 stored in database 112 as part of the user account 114, as shown in FIG. 1. For example, the requested identification data can include a credit card number for the credit card, personal identification number, an e-mail address, a residential address, or a phone number for the credit card holder 106, although the payment terminal 102 can request other types of identification data based on the stored identification data 116 stored in the database 112. In step 340, the payment terminal 102 receives the identification data through the user interface. Next, in step 350, the payment terminal 102 provides a notification of the initiation of the cardless payment transaction, along with the input identification information, to the remote payment authorization computing device 100 to enable remote authorization in accordance with aspects of the present disclosure.

Referring again to FIG. 1, remote payment authorization computing device 100 is communicatively coupled to the user device 104 through the one or more communication network(s) 110A to transmit and/or receive communications in accordance with aspects of the present disclosure.

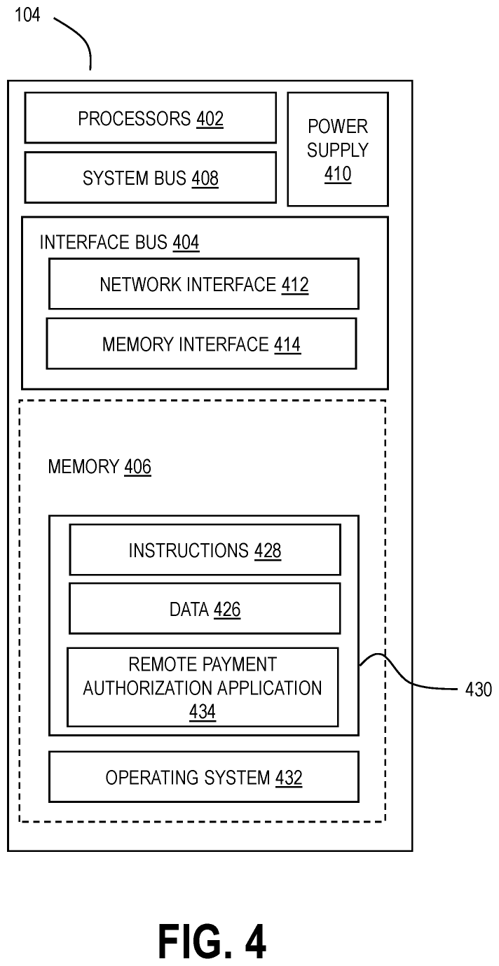

FIG. 4 illustrates one example of the user device 104. In this example, user device 104 is a mobile device, although other computing devices may be operated as the user device 104 according to aspects of the present disclosure. In the example of FIG. 4, the user device 104 includes one or more processors 402, an interface bus 404, and a memory 406, all of which may be interconnected and/or communicate through a system bus 408 containing conductive circuit pathways through which instructions (e.g., machine-readable signals) may travel to effectuate communication, tasks, storage, and the like. The user device 104 may be connected to a power source 410, which can include an internal power supply and/or an external power supply.

The one or more processors 402 may include a high-speed data processor adequate to execute the program components described herein and/or various specialized processing units as may be known in the art. In some examples, the one or more processors 402 may be a single processor, multiple processors, or multiple processor cores on a single die.

In some examples, the interface bus 404 may include a network interface 412 configured to connect the user device 104 to a communications network, such as the one or more communication network(s) 110A shown in FIG. 1, and/or a memory interface 416 configured to accept, communicate, and/or otherwise connect the user device 104 to a number of machine-readable memory devices (e.g., memory 406). In some examples, the user device 104 may transmit and/or receive information via the communication network(s) 110A to and/or from the remote payment authorization computing device 100, for example.

The memory 406 can be variously embodied in one or more forms of machine-accessible and machine-readable memory. For example, the memory 406 can include, but is not limited to, a non-transitory storage medium, a magnetic disk storage, an optical disk storage, an array of storage devices, a solid-state memory device, and the like, including combinations thereof.

Generally, the memory 406 is configured to store data/information 426 and/or instructions 428 that, when executed by the one or more processors 402, causes the user device 104 to perform one or more tasks. In particular examples, the memory 406 may include a remote payment authorization application 434 that comprises a collection of program components, database components, and/or data. According to the present disclosure, the remote payment authorization application 434 may include, but is not limited to, instructions 428 that control/operate the display screen of the user device 104 to receive notifications of cardless payment transactions and requests for authorization of such transactions, as well as to receive inputs for authorization of such transactions. The remote payment authorization application 434 may also be utilized to provide information to the remote payment authorization computing device 100 to enable/disable cardless payment transactions and/or to provide limits on when cardless payment transactions are enabled, as described in further detail below.

As shown in the example of FIG. 4, the user device 104 may further include an operating system component 432, which may be stored in the memory 406. The operating system component 432 may be an executable program facilitating the operation of the user device 104, including but not limited to, operation of the remote payment authorization application 434. Typically, the operating system component 432 can facilitate access of the interface bus 404 and can communicate with other components of user device 104 (e.g., user input device, display screen, etc.).

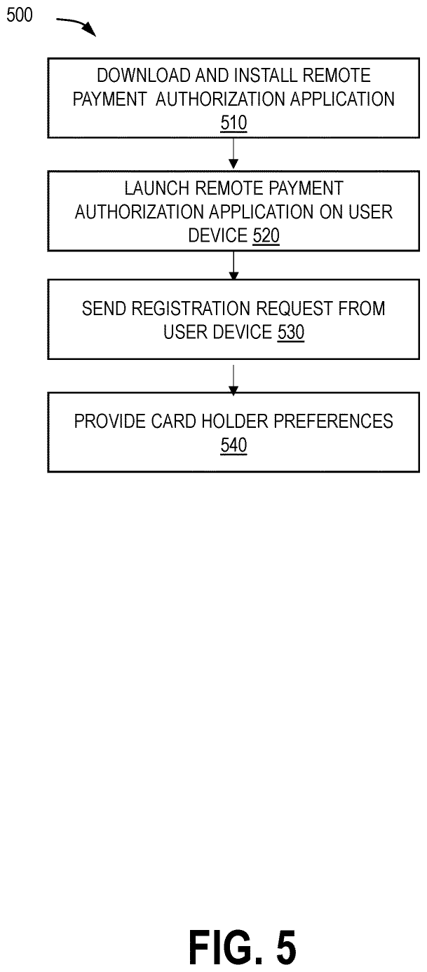

Referring again to FIG. 1, the credit card holder 106 may register to enable remote payment authorization for cardless transactions using the user device 104 to establish the user account 114. FIG. 5 is a flow chart that illustrates an example of the registration and initialization process 600 for the credit card holder 106 to establish the user account 114. In step 510, the credit card holder 106 may use the user device 104 to download and install the remote payment authorization application 434 to the user device 104. For example, the credit card holder may use the user device 104 to access one or more program repositories (e.g., Google Play®, Apple's App Store®, etc.) to download and install the remote payment authorization application 434 to the user device 104. Once downloaded and installed, in step 520 the remote payment authorization application 434 may be launched or executed on the user device 104. Put another way, an application instance for the remote payment authorization application 434 may be created using one or more processors of the user device 104.

Within the application instance of the remote payment authorization application 434, one or more requests may be transmitted from the user device 104 to the remote payment authorization computing device 100. In some examples, the credit card holder 106 may not yet have established the user account 114, as shown in FIG. 1, and therefore needs to first register with a web-based service associated with the remote payment authorization computing device 100. That is, in step 530 a registration request may be sent via the application instance executed on the user device 104 of the credit card holder 106.

In some examples, the credit card holder 106 provides user information with the registration request sent in step 530, including but not limited to, the credit card holder's 106 name, contact information, biographical information, and/or authorized devices. In further examples, the user information may include a username, account identification, one or more digital payment methods, and/or credentials used to access the user account 110 after registration. The information may be used to form the stored identification data 116 that is part of the user account 114 and used to identify the credit card holder 106 during a cardless payment transaction in accordance with the methods disclosed herein. In particular examples, the user device 104 includes a user input device, which the credit card holder 106 may use to input the user information. For instance, the user input device may include, but is not limited to, a touch-enabled display screen, a keyboard, and the like.

In the example of FIG. 5, the credit card holder 106 can also make one or more other requests using the application instance of the remote payment authorization application 434. In some examples, the one or more other requests can include, but are not limited to the card holder preferences 118 stored in database 112 as part of the user account 114, as shown in FIG. 1. By way of example, in step 540 the credit card holder 106 can provide card holder preferences 116 to enable/disable cardless payment transactions and/or to provide limits on when and/or where cardless payment transactions are enabled, as described in further detail below.

Referring again to FIG. 1, the remote payment authorization computing device 100 is communicatively coupled to the payment processor 108 by the one or more communication network(s) 110C. the payment processor 108 is associated with an entity that provides for credit card transactions, such as an issuing bank. The payment processor 108 receives transaction information from the payment terminal 102 requesting authorization of a transaction through the one or more communication network(s) 110C.

Communication network(s) 110A, 110B, and 110C can include a direct interconnection (i.e., wired), the Internet, a local area network (LAN), a metropolitan area network (MAN), a wide area network (WAN), a wired or Ethernet connection, a wireless connection, and similar types of communications networks, including combinations thereof, and may utilize a variety of information transfer protocols and/or security features (e.g., encryption, etc.). Although the communication networks 110A, 110B, and 110C are illustrated for communications between specific devices, it is to be understood that other communication configurations could be employed. In some examples, the devices illustrate in FIG. 1 can communicate over a single communication network.

Turning now to FIGS. 6A and 6B, a method 600 for enabling remote authorization of a cardless payment transaction utilizing the remote payment authorization computing device will be described with reference to FIGS. 1-6B.

In step 610, the remote payment authorization computing device 100 receives a notification of initiation of a cardless payment transaction on a credit card from the payment terminal 102. The cardless payment transaction is initiated, for example, when the credit card to be processed for the transaction is not located in the proximity of the payment terminal 102 during the cardless payment transaction. The notification includes identification data related to the credit card holder 106 of the credit card for payment of the cardless payment transaction, such as the credit card number for the credit card, personal identification number, an e-mail address, a residential address, or a phone number for the credit card holder 106. The notification of the initiation of the cardless payment transaction is based on a user selection of a cardless payment transaction on the payment terminal 102. For example, the payment terminal 102 can provide an option for the user to select a cardless payment transaction as described in the method 400.

In step 620, the remote payment authorization computing device 100 sends a query to the database 112 including the identification data received in step 610. The database includes stored identification data for a plurality of cardholders registered to conduct remote payment authorizations of cardless transactions. The query allows the remote payment authorization computing device 100 to determine whether the credit card for which the cardless payment transaction is requested is associated with a registered user of the remote payment authorization system to allow cardless payment transactions.

In step 630, the remote payment authorization computing device 100 receives a response from the database 112 and determines whether the information data received along with the notification of the initiation of the cardless payment transaction matches stored information data in one of the user accounts, such as stored information data 116 associated with user account 114. If in step 620, the received information data does not match any stored information data in database 112, it is determined that the credit card for which the cardless payment transaction was initiation is not associated with a registered user and the No branch is taken to step 640. In step 640, the remote payment authorization computing device 100 provides a denial message to the payment terminal 102 to decline the cardless payment transaction. The cardless payment transaction is then cancelled at the payment terminal 102 and the user must select another payment method. If in step 630, the received information data matches stored information data in a user account, such as user account 114 for the credit card holder 106, the Yes branch is taken to step 650.

In step 650, the remote payment authorization computing device 100 determining the identity of the credit card holder 106 based on the identification data received in step 610. In this example, the received information data is correlated to stored information data 116 in the user account 114. The user account 114 includes the identity of the credit card holder 106, as well as an identification of the user device 104, such as a mobile device, associated with the credit card holder 106.

In step 660, the remote payment authorization computing device 100 determines whether the credit card holder 106 identified in step 650 has enabled cardless payment transactions. Thus, the remote payment authorization computing device 100 determines whether cardless payment transactions are enabled prior to completing the remaining steps of the method 700. This prevents the card holder 106 from receiving unwanted requests for cardless payment transaction authorizations.

Whether cardless payment transactions are enabled may be determined based on the card holder preferences 118 stored in the user account 114 on the database 112 and provided along with the identification data 116. In some examples, the card holder preferences 118 can indicate whether the credit card holder 106 has selected to enable cardless payment transactions through the remote payment authorization application 434 on the user device 104. This feature allows the credit card holder 106 to toggle cardless payment authorization on and off on the user device 104. Thus, the credit card holder 106 controls when cardless payment transactions are authorized. In one example, the credit card holder's 106 input in the remote payment authorization application 434 can be sent to the remote payment authorization computing device 100 as an API call and stored as part of the card holder preferences 118 in the database 112. Although the toggle feature is described with respect to cardless payment transactions, the feature could be employed to allow the credit card holder 106 to enable/disable other payment features.

In some examples, the card holder preferences 118 can include a location-based restriction, a merchant-based restriction, and/or a time-based restriction. For instance, a location-based restriction may limit the ability to complete a cardless payment transaction unless the transaction is occurring in a predefined location (e.g., a cardless payment transactions may only be enabled within a particular country, or within a particular city, for example, according to a location-based restriction). However, it should be appreciated that other types of location-based restrictions may be employed.

In another instance, a merchant-based restriction may limit the ability to complete cardless payment transactions unless the transaction is occurring in at a predefined merchant or type of merchant (e.g., a cardless payment transaction may only be used at grocery stores and restaurants, or only at transportation companies, according to a merchant-based restriction). However, it should be appreciated that other types of merchant-based restrictions may be employed.

In yet another instance, a time-based restriction may limit the ability to complete cardless payment transactions unless the transaction is occurring within a predefined period of time (e.g., the cardless payment transactions may only be used on the first weekend of every month, or during a particular week, according to a time-based restriction). According to another example, the time-based restriction is a predetermined time limit during which cardless payment transactions are enabled to make a payment. For example, the credit card holder 106 may decide that the cardless payment transactions should be enabled during a particular time period such as an evening, a holiday, or other time period. When that time period has ended, the predetermined time limit is up and cardless payment transactions are no longer enabled in the card holder preferences 118. It should be appreciated that other types of time-based restrictions may be employed.

In yet another instance, a transaction amount-based restriction may limit the ability to complete cardless payment transactions unless the transaction is below a certain dollar value. For example, the credit card holder 106 may decide that the cardless payment transactions should be enabled only for transactions below $500. It should be appreciated that other types of transaction amount-based restrictions may be employed.

If in step 660, the remote payment authorization computing device 100 determines that cardless payment transactions are not enabled based on the card holder preferences 118, the No branch is taken to step 640, and the remote payment authorization computing device 100 provides a denial message to the payment terminal 102 to decline the cardless payment transaction. The cardless payment transaction is then cancelled at the payment terminal 102 and the user must select another payment method. If in step 660, the remote payment authorization computing device 100 determines that cardless payment transactions are enabled based on the card holder preferences 118 and the transaction details, the Yes branch is taken to step 670.

In step 670, the remote payment authorization computing device 100 sends an authorization request for the cardless payment transaction to the user device 104 associated with the credit card holder 106. The authorization request can be sent, for example, as a push notification, a text message, or a phone call, although other types of authorization requests can be utilized. In an aspect, the request for authorization comprises transaction data related to the cardless payment transaction from the payment terminal, such a transaction location, merchant identification, transaction type (e.g., gas, groceries, restaurant, etc.), or a transaction amount. The authorization request provides information on the transaction to the credit card holder 106 and allows the credit card holder 106 to provide an authentication to approve the transaction, for example, through the remote payment authorization application 434, as described below. The authentication from the credit holder 106 may include providing a personal identification number for the credit card or a biometric authentication, such as a facial scan or thumbprint entered through the user device 104.

In step 680, the remote payment authorization computing device 100 determines whether an approval and authentication for the cardless payment transaction are received from the user device 104. In one example, the remote payment authorization computing device 100 may wait for an approval for a pre-determined time. If in step 680, no approval is received in the pre-determined time or if the credit card holder 106 declines to approve the cardless payment transaction, the No branch is taken to step 640 where the remote payment authorization computing device 100 provides a denial message to the payment terminal 102 to decline the cardless payment transaction. The cardless payment transaction is then cancelled at the payment terminal 102 and the user must select another payment method. If in step 680, the remote payment authorization computing device 100 receives and approval and authentication for the cardless payment transaction from the user device 104, the Yes branch is taken to step 690.

In step 690, the remote payment authorization computing device 100 provides an approval message to the payment terminal 102 for the cardless payment transaction to the payment terminal based on the authentication provided by the credit card holder 106. The payment terminal 102 can then process the cardless payment transaction by, for example, getting approval through the payment processor 108 in the standard fashion.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A method for enabling authorization of a cardless payment transaction, the method comprising:
receiving, by a payment authorization computing device, a notification of initiation of a cardless payment transaction on a credit card from a payment terminal, wherein the notification comprises identification data related to a holder of the credit card for payment of the cardless payment transaction;
determining, by the payment authorization computing device, an identity of the holder of the credit card based on the identification data, wherein the identity of the holder of the credit card comprises a mobile device associated with the holder of the credit card;
determining, by the payment authorization computing device, whether the credit card holder has enabled cardless payment transactions;
sending, by the payment authorization computing device, a request for authorization of the cardless payment transaction to the mobile device associated with the holder of the credit card; and
providing, by the payment authorization computing device, an approval for the cardless payment transaction to the payment terminal based on an authentication provided by the holder of the credit card on the mobile device in response to the request for authorization of the cardless payment transaction.

2. The method of claim 1, wherein the notification of the initiation of the cardless payment transaction is based on a user selection on the payment terminal.

3. The method of claim 1, wherein the credit card is not located in the proximity of the payment terminal during the cardless payment transaction.

4. The method of claim 1, wherein the identification data comprises a credit card number for the credit card, personal identification number, an e-mail address, or a phone number for the holder of the credit card.

5. The method of claim 1, wherein the determining the identity of the holder of the credit card comprises:
sending, by the remote payment authorization computing device, a query to a database comprising identification data for a plurality of cardholders; and
receiving, by the remote payment authorization computing device, the identity of the credit card holder from the database in response to the query.

6. The method of claim 1, wherein the determining the identity of the holder of the credit card comprises:
determining, by the authorization computing device, whether the holder of the credit card has registered to allow cardless payment transactions; and
sending, by the authorization computing device, a denial of the cardless payment transaction to the payment terminal when it is determined that the holder of the credit card has not registered to allow cardless payment transactions.

7. The method of claim 1, wherein the determining whether the credit card holder has enabled cardless payment transactions is performed prior to sending the request for authorization of the cardless payment transaction to the mobile device associated with the holder of the credit card.

8. The method of claim 7, wherein information related to whether the credit card holder has enabled cardless payment transactions is stored in a database along with the identity of the card holder.

9. The method of claim 8, wherein the information related to whether the credit card holder has enabled cardless payment transactions indicates a temporal period during which cardless payment transactions are enabled.

10. The method of claim 8, wherein the information related to whether the credit card holder has enabled cardless payment transactions indicates a transaction type or transaction amount for which cardless payment transactions are enabled.

11. The method of claim 1, wherein the request for authorization comprises transaction data related to the cardless payment transaction from the payment terminal.

12. The method of claim 11, wherein the transaction data comprises a transaction location, a transaction type, or a transaction amount.

13. The method of claim 1, wherein the authentication comprises a personal identification code associated with the credit card holder or a biometric identification of the credit card holder.

14. A payment authorization computing device comprising a memory comprising programmed instructions stored thereon, and one or more processors configured to be capable of executing the stored programmed instructions to:
receive a notification of initiation of a cardless payment transaction on a credit card from a payment terminal, wherein the notification comprises identification data related to a holder of the credit card for payment of the cardless payment transaction;
determine whether the holder of the credit card has registered to allow cardless payment transactions based on the identification data;
determine whether the credit card holder has enabled cardless payment transactions;
send a request for authorization of the cardless payment transaction to the mobile device associated with the holder of the credit card; and
provide an approval for the cardless payment transaction to the payment terminal based on an authentication provided by the holder of the credit card on the mobile device in response to the request for authorization of the cardless payment transaction.

15. The device of claim 14, wherein the memory includes further program instructions executable by the processor to:
send a denial of the cardless payment transaction to the payment terminal when it is determined that the holder of the credit card has not registered to allow cardless payment transactions.

16. The device of claim 15, wherein information related to whether the credit card holder has enabled cardless payment transactions is stored in a database along with the identity of the card holder.

17. The device of claim 16, wherein the information related to whether the credit card holder has enabled cardless payment transactions indicates a temporal period during which cardless payment transactions are enabled.

18. The device of claim 16, wherein the information related to whether the credit card holder has enabled cardless payment transactions indicates a transaction type or transaction amount for which cardless payment transactions are enabled.

19. A method for authorizing a cardless payment transaction on a user computing device associated with a holder of a credit card, the method comprising:
sending, by the user computing device, one or more user preferences to a payment authorization computing device, wherein the one or more user preferences can be used by the payment authorization computing device to determine whether the holder of the credit card has enabled the cardless payment transaction;
receiving, by the user computing device, a request for authorization of the cardless payment transaction when the payment authorization computing device determines that the holder of the credit card has enabled the cardless payment transaction based on the one or more user preferences; and
sending, by the user computing device, an authentication provided by the holder of the credit card on the user computing device to the payment authorization computing device in response to the request for authorization of the cardless payment transaction to authorize the cardless payment transaction.

20. The method of claim 19, wherein the one or more user preferences comprise a temporal period during which cardless payment transactions are enabled, a transaction type for which cardless payment transactions are enabled, or a transaction amount for which cardless payment transactions are enabled.
